(19) United States
(12) Patent Application Publication
(10) Pub. No.: US 2006/0176888 A1
(43) Pub. Date: Aug. 10, 2006

(54) High density network topology

(76) Inventor: Tod W. McNamara, Rowley, MA (US)

Correspondence Address: KRISTOFER E. ELBING, 187 PELHAM ISLAND ROAD, WAYLAND, MA, 01778, US

(21) Appl. No.: 11/204,283

(22) Filed: Aug. 15, 2005

Related U.S. Application Data
(63) Continuation of application No. 09/828,298, filed on Apr. 6, 2001, now abandoned.
Application No. 09/828,298 is a continuation-in-part of application No. 09/398,663, filed on Sep. 17, 1999, now Pat. No. 6,262,976.
(60) Provisional application No. 60/100,723, filed on Sep. 17, 1998.

(51) Int. Cl. H04L 12/56

(52) U.S. Cl. 370/401; 370/406

(57) ABSTRACT

A network is disclosed that includes a first subnetwork including a first plurality of nodes interconnected by a first plurality of links, with nodes in the first plurality having a first capacity. A second subnetwork includes a second plurality of nodes interconnected by a second plurality of links, with nodes in the second plurality having a second capacity, and with the second capacity being higher than the first capacity. A third plurality of links is also provided between nodes in the first subnetwork and the second subnetwork.

### CROSS-REFERENCE TO RELATED APPLICATION

This application claims priority to U.S. patent application Ser. No. 09/398,663, filed Sep. 17, 1999, and through it U.S. provisional application No. 60/100,723, which was filed Sep. 17, 1998 and was claimed as a priority application to PCT application no. PCT/US99/21684, entitled System and Method for Network Flow Optimization Using Traffic Classes, filed Sep. 17, 1999, and published Apr. 6, 2000 as PCT publication no. WO019680, all of which are herein incorporated by reference.

### FIELD OF THE INVENTION

This invention relates to network topologies applicable to different types of networks, such as packet-based data communication networks.

### BACKGROUND OF THE INVENTION

Many technological systems are based on large networks. These include telephone networks, multi-processor computer arrays, and packet-based computer networks, such as Local Area Networks (LANs) or the Internet. The performance of network technologies therefore has an impact on a variety of disciplines, and, as a result, numerous types of network topologies have been proposed.

Two well-known network topologies include lattice and star topologies. As shown in FIG. 1, star (or “mesh”) topologies simply provide a single connection between every node. As a result, the total hop distance is always equal to one under non-fault conditions. And even under single fault conditions, star topologies will exhibit uniform and predictable performance, with a maximum hop distance of two.

Unfortunately, star topologies require a large number of interconnections, which can make them difficult to implement in practical systems. The number of links required for a network that has n nodes is equal to:
Σ(n−1) or n(n−1)/2

This formula shows that a 25-node network, for example, would require 300 links to interconnect all of its nodes using a mesh topology. Some of the characteristics of other network sizes are outlined in Table 1.

TABLE 1

| | | Total Links | Minimum & | |
|---|---|---|---|---|
| | Node Links | Σ(n − 1) | Maximum | |
| Node n | (n − 1) | n(n − 1)/2 | Hops | Fault Hops |
| 5 | 4 | 10 | 1 | 2 |
| 25 | 24 | 300 | 1 | 2 |
| 50 | 49 | 1225 | 1 | 2 |
| 125 | 124 | 7750 | 1 | 2 |
| 250 | 249 | 31125 | 1 | 2 |
| 500 | 499 | 124750 | 1 | 2 |

The characteristics listed in table 1 show that the star topology performs uniformly under both normal and fault conditions. Because there are connections between all nodes, traffic between any two nodes does not affect traffic between other node pairs. As the number of nodes increases, however, the connectivity level becomes much more impractical to implement within either a high-density fabric or an external backbone.

Lattice topologies form a cube in three-dimensional space, as presented in FIG. 2. Each node in this type of topology has six connections, with one to each of its neighbors. Larger numbers of nodes result in a larger cube, with more interconnections and more hops between more distant neighbors. Table 2 depicts several characteristics for cubic lattice topologies of varying densities.

TABLE 2

| | Node Links | | | | |
|---|---|---|---|---|---|
| Node | Corner: 8 @ 3, Edges: 12(n − 2) @ | Total | | | |
| (n) | 4, Face: 6 (n − 2)\hat{ }2 @ | Links | Congestion | Min. | Max. |
| n\hat{ }3 | 5, Inner: (n − 2)\hat{ }3@6 | (n\hat{ }3)(n − 1) | Ratio | Hops | Hops |
| 27 (3) | 8@3, 12@4, 6@5, 1@6 | 54 | 4/1 | 1 | 9 |
| 64 (4) | 8@3, 24@4, 24@5, 8@6 | 192 | 4/1 | 1 | 12 |
| 125 (5) | 8@3, 36@4, 54@5, 27@6 | 500 | 4/1 | 1 | 15 |
| 216 (6) | 8@3, 48@4, 96@5, 64@6 | 1080 | 4/1 | 1 | 18 |
| 343 (7) | 8@3, 60@4, 150@5, 125@6 | 2058 | 4/1 | 1 | 21 |
| 512 (8) | 8@3, 72@4, 216@5, 216@6 | 3584 | 4/1 | 1 | 24 |
| 729 (9) | 8@3, 84@4, 294@5, 343@6 | 5832 | 4/1 | 1 | 27 |

The first column of Table 2 presents the total number of internal interconnected nodes, the second column lists the number of nodes and their respective connectivity density, and the third column presents the total number of internal connections required within the lattice. The contents of this third column show an improvement in connectivity density over the star topology. Unfortunately, this improvement comes at a price, however, and this price is apparent from the fourth column, which lists the number of external nodes feeding an internal link before the internal link congests. This number represents the ratio between the external carrying capacity and the internal carrying capacity, and is four for this network topology. But because each interior and face node has more than four neighbor node links, interior and face node links may congest from immediate neighbor node traffic. The congestion performance for this topology is therefore highly inter-dependent and non-deterministic for traffic between any arbitrary set of source and destination pairs.

Numerous variations and modifications of these two basic network topology types have been proposed. Yet despite significant demand for improvements in network performance, none of these has been conclusively shown to present an optimal solution for high-speed, efficient, and cost-effective handling of traffic in large networks.

### SUMMARY OF THE INVENTION

Several aspects of the invention are presented in this application. These are applicable to a number of network technologies.

Networks organized according to principles of the invention can exhibit better performance than networks that are based on both star topologies and lattice topologies. Networks according to the invention can exhibit better congestion performance than lattice topologies because the arrangement of node capacities can be defined such that the nodes are difficult or impossible to congest. And they can exhibit lower connection densities than star-connected topologies because they require fewer interconnections.

Networks according to the invention can exhibit excellent congestion performance as well. Such networks can be designed to allow any node to communicate with any other node in the network, as long as each of them has the communication capacity necessary. No amount of traffic between other nodes can then interfere with the communication. This deterministic performance avoids the performance degradation that is often associated with network traffic increases in prior art networks.

Networks according to the invention can exhibit good hop performance as well. Cross-connections in these networks can allow for one or two-hop inter-areas transfers in many instances, with longer hop distances resulting only from the number of scale levels. And using appropriate routing, the maximum hop distance can be bounded for any given fault condition.

Networks according to the invention may also benefit from much simpler routing protocols than do existing networks. Since other network traffic does not affect communication between any two nodes, routing protocols need not take this traffic into account. As a result, routing logic can be made to be more simple and straightforward, resulting in simpler, more reliable, and/or more highly integrated implementations.

Networks according to the invention may further be advantageous in that they can be easily expanded and scaled. Existing networks can be easily upgraded to improve performance by scaling groups of their nodes, without requiring changes in topology. And additional scale levels can also be added, or partially filled scale levels can be filled in to expand the number of nodes in the network without changing existing portions of the network.

Networks according to the invention may also exhibit improved latency performance.

### BRIEF DESCRIPTION OF THE DRAWINGS

FIG. 1 is a three-dimensional network topology diagram of a prior art five-node star network;

FIG. 2 is a three-dimensional network topology diagram of a prior art 64-node lattice network;

FIG. 3 is a three-dimensional network topology diagram for a 25-node scaled-star network according to the invention;

FIG. 4 is a three-dimensional network topology diagram for a five-node star network portion with the addition of a higher scale node,

FIG. 5 is a three-dimensional network topology diagram for the five-star network and higher scale node of FIG. 4 with arrows showing down-scale traffic;

FIG. 6 is a three-dimensional network topology diagram for the five-star network and higher scale node of FIG. 4 with arrows showing up-scale traffic;

FIG. 7 is a three-dimensional network topology diagram for the five-star network and higher scale node of FIG. 4 with arrows showing local traffic;

FIG. 8 is a three-dimensional network topology diagram for a 30-node network portion,

FIG. 9 is a two-dimensional network topology diagram for a 30-node scaled-star network;

FIG. 10 is a simplified two-dimensional diagram of the network of FIG. 9;

FIG. 11 is a simplified two-dimensional diagram of the network of FIG. 9 showing an illustrative single-hop inter-area transfer;

FIG. 11 is a simplified two-dimensional diagram of the network of FIG. 9 showing an illustrative double-hop inter-area transfer;

FIG. 12 is a simplified two-dimensional diagram of the network of FIG. 9 showing another illustrative double-hop inter-area transfer;

FIG. 13 is a flowchart illustrating the operation of the network of FIG. 9; and

FIG. 14 is a simplified two-dimensional diagram of a network according to the invention that uses two scale levels.

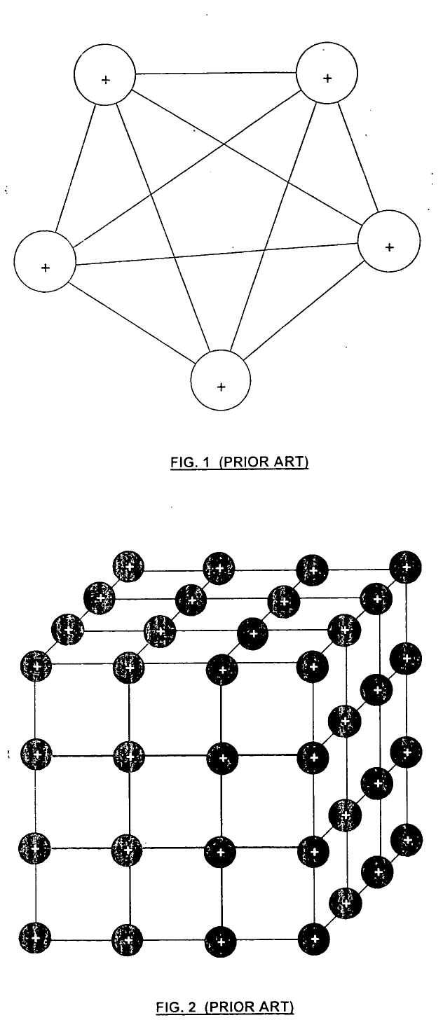

### DETAILED DESCRIPTION OF AN ILLUSTRATIVE EMBODIMENT

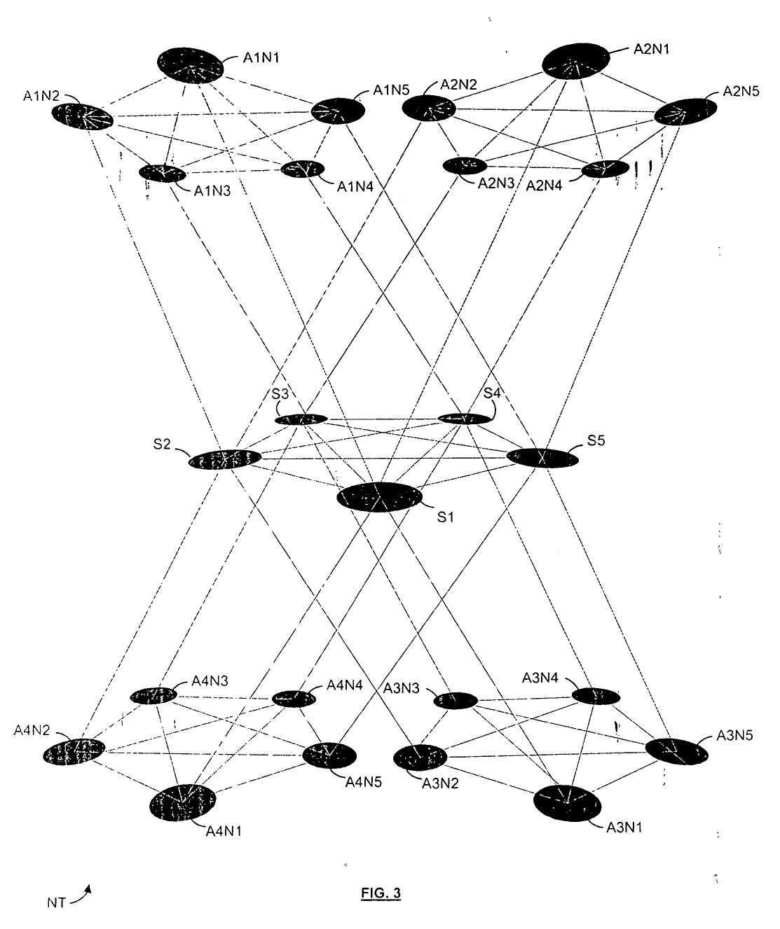

Referring to FIG. 3, an illustrative network NT according to the invention includes a number of low-scale subnetworks or areas A1, A2, A3, A4, and a high-scale subnetwork or scale S. The low-scale subnetworks and the high-scale subnetwork both include a series of interconnected nodes. These nodes can represent different types of network elements, such as switches, routers, or processors, and the interconnections can represent wired, wireless, or virtual signal paths that are continuously or intermittently available.

In one embodiment, the illustrative network is implemented as a packet-based Ethernet LAN switch made up of a series of digital switches and external connectors interconnected by internal circuit lines. This switch can employ a modular construction in which the subnetworks are implemented as separate entities, such as circuit boards or integrated circuits. These modular entities can then be assembled to achieve different network configurations.

The nodes in the low-scale network have a predetermined capacity and nodes in the high-scale subnetworks have a predetermined capacity that is higher than that of the nodes in the low-capacity subnetworks. In communication networks, capacity will generally be understood to the node's worst-case bandwidth, although other capacity measures may also be useful. In this embodiment, the low-scale subnetworks and the high scale subnetworks are all five-node mesh networks (i.e., n=5), and the higher scale nodes have four times the capacity of the lower scale nodes.

There are a number of interconnections between the low-scale subnetworks and the high-scale subnetwork. In this embodiment, there is an interconnection between each node in the high-scale subnetwork (S1, S2, S3, S4, and S5) and one different, corresponding node in each of the low-scale subnetworks (respectively A1N1, A2N1, A3N1, A4N1; A1N2, A2N2, A3N2, A4N2; A1N3, A2N3, A3N3, A4N3; A1N4; A2N4, A3N4, A4N4; and A1N5, A2N5, A3N5, A4N5). This inter-scale connection topology can be analogized to a series of intersecting barrels. Each barrel has a the same top, but a different base, and the top and bottom are interconnected by a series of vertical connections, like the slats of a barrel.

The topology employed in the illustrative network effectively separates local neighbor traffic from traffic that is more distant. This separation of traffic classes by distance can be analogized to the inclusion of higher speed lanes on a highway. The higher speed lanes are separated from local exchange traffic preventing the two from interfering with each other.

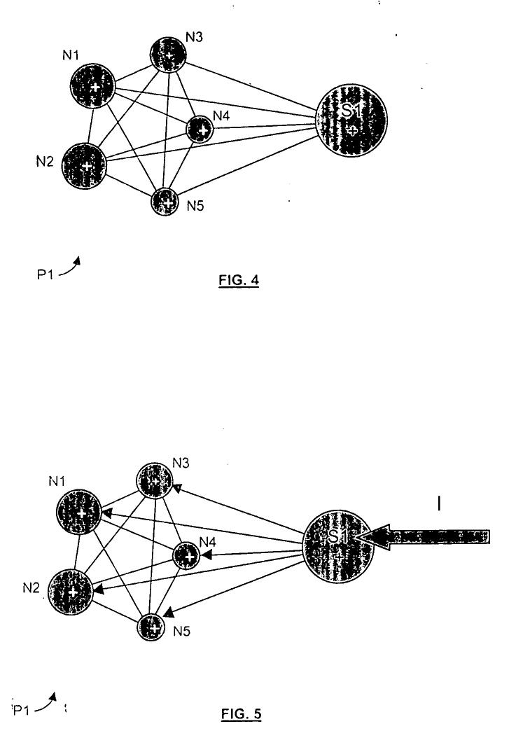

To understand some of the benefits of the topologies according to the invention, it is useful to examine smaller network portions. FIG. 4 presents a network portion P1 that will be used to illustrate the effects of connecting a higher scale node to lower scale nodes N1, N2, N3, N4, N5 in a five-node star area. The external link at the scale node has five times the capacity of the external links at each node within the star network.

Referring to FIG. 5, inbound traffic I from the higher scale S1 node need not result in additional neighbor node traffic within the lower scale nodes N1, N2, N3, N4, N5 in the star network. Since the scale node is connected to all of the lower scale nodes, traffic introduced at the higher scale node S can follow a direct path to each node within the small star network. If the scale link were to carry traffic at capacity for each node within the area to destination on their external links, each scale link would be at capacity and the external link for S would be at capacity. The inter-node local links, however, would have no data traffic. The scale node can therefore saturate the area nodes without affecting the traffic between nodes.

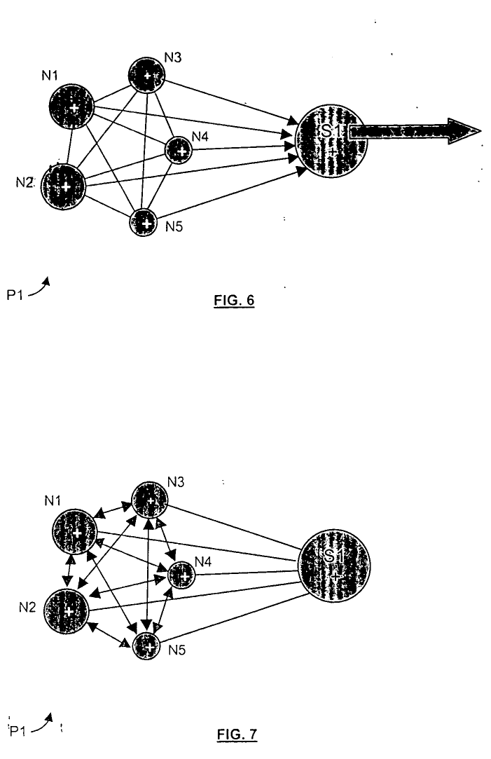

Referring to FIG. 6, traffic at scale also supports any combination of traffic from the area nodes. The capacity of the external link of the scale node S is n times the capacity of the links of the node within the area. As a result, even the maximum traffic level from all n nodes in the star will not saturate the scale node.

And, as presented in FIG. 7, no level of inter-node traffic within an area will load the inter-scale traffic. As discussed above, the star network provides adequate capacity for any level of communication between the nodes in the network. Traffic within the network therefore need not be routed through the scale node outside of the star network to reach other nodes in the network.

FIGS. 4-7 demonstrate that traffic breaks down into three directional classes: area local, upscale (away from the area), and downscale (toward the area). These figures also show that as long as the external link at the scale switch is n times greater than the external links within an area of n nodes, the area traffic will not congest the next-scale traffic under any conditions.

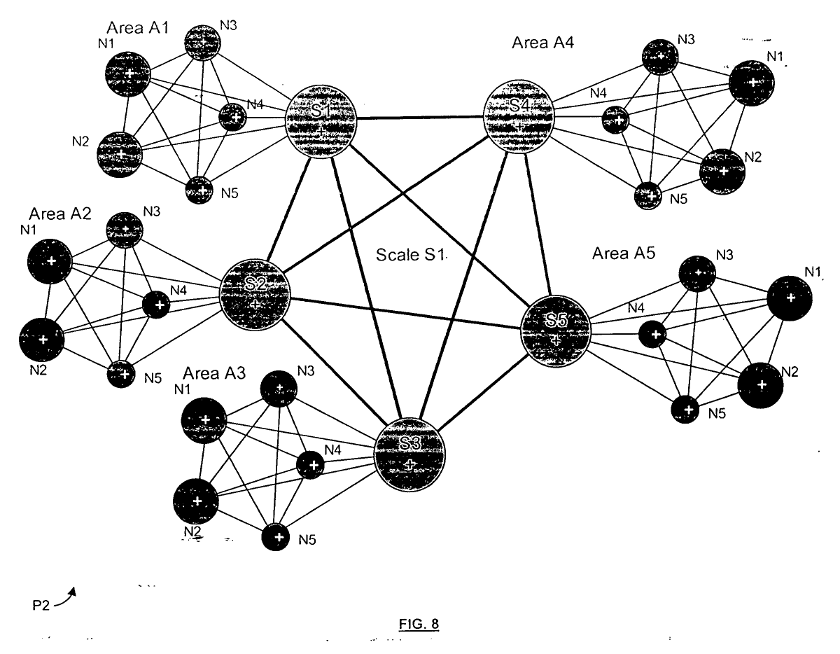

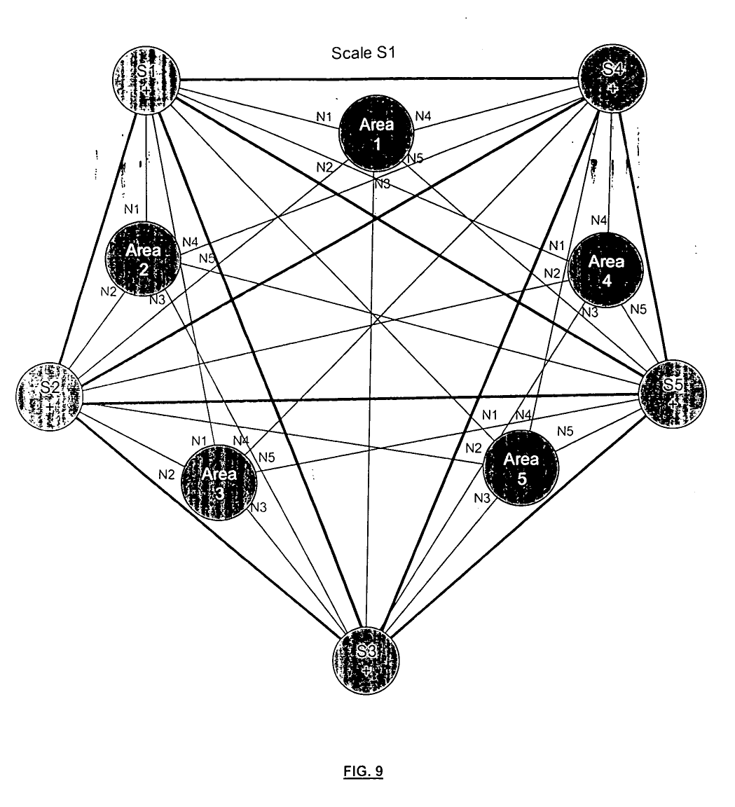

Referring to FIG. 8, it is also useful to examine a larger network portion P2 to understand the various properties of networks according to the invention. This network portion includes a star-connected, high-scale subnetwork. Each node in this subnetwork is connected to each of five nodes in a different one of five low-scale, star-connected subnetworks.

Although this network portion is of a more useful density level than the network portion P1 discussed above in connection with FIGS. 4-7, two problems remain relative to the scaled star network shown in FIG. 3. First, since the scale interconnects for an area connect to the same scale node, a failure in that scale node will isolate the area from the rest of the network. In addition, communication between areas must always make one hop in the high-scale subnetwork to reach a node within another area.

Referring to FIG. 9, placing inter-scale links from one area to different nodes at a higher scale mitigates both problems, while maintaining traffic class separation. In the two-dimensional view presented in FIG. 9, a circle replaces the local area-node complexity. As was shown in FIG. 3, each node within an area can connect to the same numbered node at the higher scale. This scaled-star interconnection scheme eliminates the single-node failure isolation and reduces the number of hops for inter-scale connections.

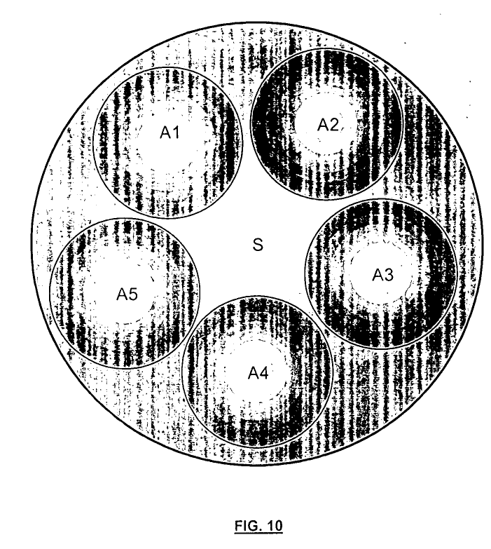

Referring to FIG. 10, the full three-dimensional and partially simplified two-dimensional representations of the interconnections for scaled star topologies presented in FIGS. 3 and 9 of this application are unfortunately quite complex for all but the simplest networks. It is therefore useful to represent such networks using more highly simplified, shaded two-dimensional diagrams. In these diagrams, a scaled star topology appears as a series of balls clustered together within other balls. Each star-interconnected area subnetwork of nodes A1, A2, A3, A4, A5 grouped together by local neighbor links is represented as a small ball. A larger ball represents the nodes and interconnections of the scale subnetwork S. Showing the smaller balls surrounded by the larger balls implies that area subnetworks are connected to a scale subnetwork by inter-scale links. The surface of each small ball includes nodes within an area. The small balls representing areas are represented as evenly spaced within the larger ball because each switch on the surface of the small balls connects with a corresponding scale switch on surface of the large ball. Data flow at a given scale level (intra-area) in this model is viewed as flowing along the surface of a ball. Only when data flows between scales does the data penetrate a ball or emit from a ball.

Referring to FIG. 11, the performance of the single-scale, n=five, star topology network of FIGS. 9 and 10 will now be discussed. First, for traffic within an area, the performance mirrors star topology performance with one hop for both minimum and maximum performance. For inter-area traffic, traffic must exit an area for an upscale hop HU. If a scale node S directly connects a departure area node (e.g., A2N1) to a destination area node (e.g., A3N1), data would then travel directly back down to the destination area and node in a second hop HD (see also the path from A2N1 to A3N1 via S1 in FIG. 3). This path will occur on average 20% of the time for n=five scaled star topologies, and is available because each switch is cross-connected between the areas and the scale switches.

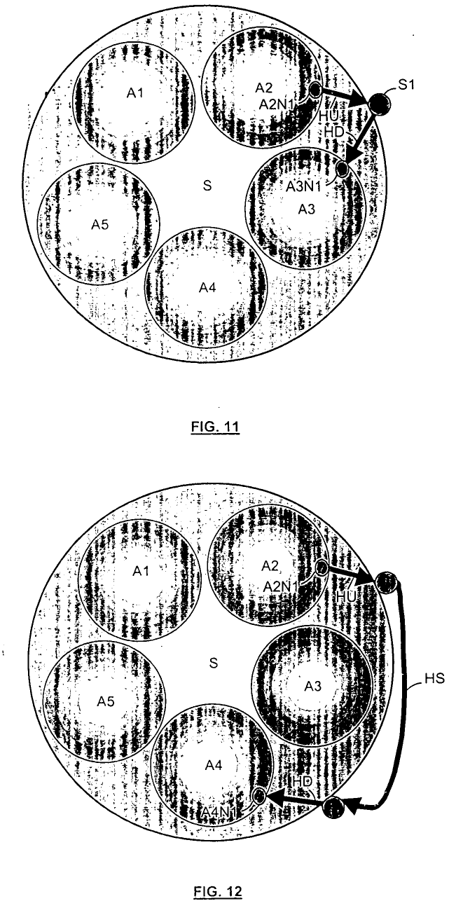

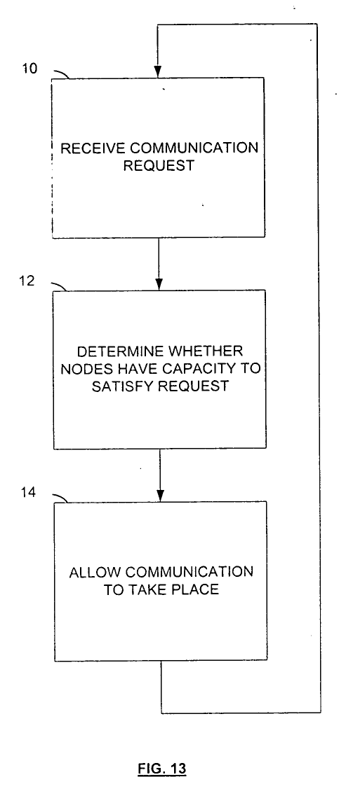

As shown in FIG. 12, when a scale node S does not directly connect a departure area node (e.g., A2N1) to a destination area node (e.g., A4N2), data can not travel directly back down to the destination node after the initial upscale hop HU. Instead, it must make another hop, for a total of three hops. As shown in FIG. 12, this hop can be a first scale-level hop HS that takes place before a final downscale hop HD (see also the path from A2N1 to A3N2 via S1 in FIG. 3). This path will occur on average 80% of the time for n=five scaled star topologies. Note that other types of three-hop communications could also exist, in which additional hops occur in either the departure or destination areas, but these can interfere with other traffic in these areas.

The performance of a scaled star topology with five-node areas (n=5) and one scale level (s=1) is summarized in Table 3.

TABLE 3

| | Minimum Hops | Maximum Hops |
|---|---|---|
| Intra-Area | 1 | 1 |
| Inter-Area | 2 | 3 |

A marginal increase in hop distance or connective performance from star topologic performance is apparent from Table 3. But this topology has inter-connected thirty nodes at two scale factors essentially without inter-dependencies that would affect performance between any two node pairs. All communication characteristics are instead deterministic between any source and destination pair.

Referring to FIG. 13, because scaled star networks can be designed to allow for deterministic communication characteristics between any source and destination pair, they can exhibit excellent performance even under heavy loads. Communication can be allowed (step 12) between any two nodes in the network independent of other traffic on the network, as long as it is determined that both nodes themselves have enough free capacity to support the communication (step 14). This aspect of the protocol can be implemented in the network with simple communication-enabling logic, which allows or disallows communication between nodes based on their available capacities.

In addition, because routing is independent of traffic conditions, it can be greatly simplified. Since all paths are deterministic, routing functions need only depend only on the identity of the destination node. When faults occur, a simple round-robin protocol can be followed to distribute fault traffic through different fault paths. For example, when a failed scale node makes an area node unreachable directly, traffic to it is successively routed to it via each of the other nodes in the area. When an end node fails, virtual channels between it and other nodes will time out, freeing up bandwidth for other connections.

Each node maintains a data structure expressing its aggregate capacity. When a virtual channel is established between two nodes, these nodes use the data structure to allocate a portion of their capacity to the channel. When a channel is no longer needed, the capacity can be allocated to other channels. When all of a node's capacity has been used up, further channels can be refused. This simple data structure, coupled with the simple routing protocol described above, and the ability to negotiate channel set-up allow a simple, inexpensive node to perform as part of a high-performance network.

Networks according to the invention can exhibit monotonic or even linear performance. As the number of communications carried by the network increases, the throughput of the network generally increases at a proportional rate, resulting in a linear performance characteristic. When no more communications can be made, the performance characteristic can no longer increase, and the performance characteristic stays at a particular maximum level. This performance characteristic is a substantial improvement over some prior art network architectures whose performance improves with demand up until a certain level, but then degrades substantially as the network becomes congested. This type of nonlinear, non-monotonic performance characteristic can be particularly vexing because network performance decreases during periods of highest demand, when such performance decreases are most disruptive.

The cost of these improvements to the inter-node connectivity level of the network will now be analyzed, beginning with an examination of bandwidth between scales for conditions of no congestion. If the base or intra-area bandwidth is represented by bw, then for the second scale to handle full carrying capacity of any area its bandwidth would have to be n (bw). Including the effects of the scale levels, the formula becomes (nˆs)(bw), for the bandwidth at each scale required for full capacity.

The number of nodes associated with a scaled star can be derived from the following formula:
Σnˆ(s+1), for s starting at zero, s=0.
For s=1 and n=5, the total number of nodes is therefore equal to nˆ2+nˆ1=nˆ2+n, with n=5, which results in a total number of nodes that is equal to 30.

The total number of links required will now be determined. The formula presented above for star topologies can be used to determine the number of links per area and the number of links within a scale. Since the total number of links per area including scale links is: n(n+1)/2, and the number of links at scale is n(n−1)/2 these terms can be determined by:
Σnˆ(s−1)[n(n(n+1))/2]+nˆ(s−1)[n(n−1)/2]
For s=1, this becomes (nˆ2)(n+1)/2+n(n−1)/2, and with n=5, it becomes 150/2+20/2=85. This reduces to:
1/2Σnˆ(s−1)[(nˆ3)+2(nˆ2)−n] from s=1.
The inter-scale links can be shared links of the higher scale or individual links of the lower scale. These formulas are based on the links being of lower scale. If the links are of higher scale and shared, the formula for the total number of links changes to:
Σnˆ(s−1)[n(n(n−1))/2+1]+n(n−1)/2]
For s=1, this becomes (nˆ2)(1−1)/2+n+n(n−1)/2, and for n=5, it becomes 100/2+5+20/2=65. This reduces to:
½Σnˆ(s−1)[(nˆ3)+n], from s=1.
In this illustration, node density has grown into the high-density category, and based on tabulated values, hop performance has increased by two hops per scale.

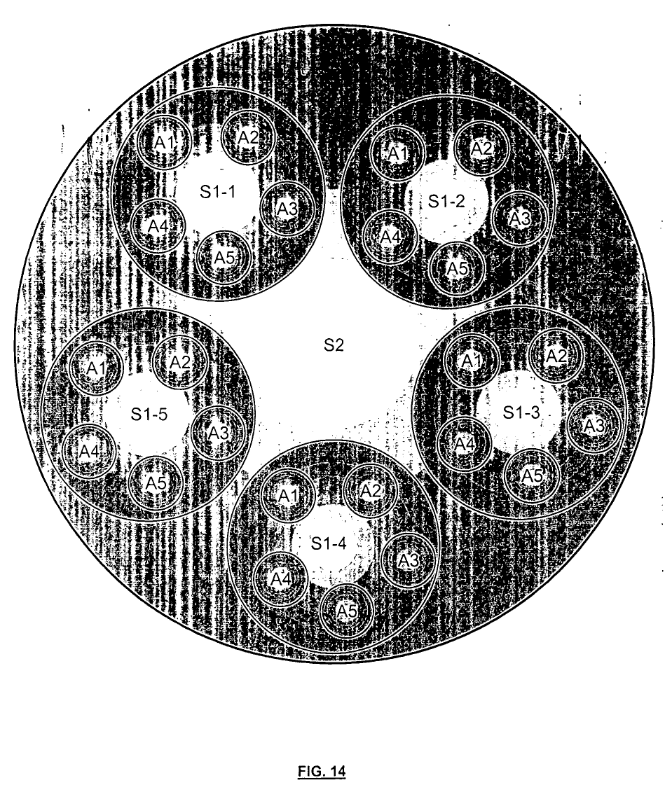

Methods of increasing node density will now be discussed. These can include increasing the number of nodes per area, which increases the number of nodes directly in step with the star topology. Node density can also be increased by increasing the number of scales. For example, as shown in FIG. 14, an n=5, m=2 scaled star network can include five scales S1-1, S1-2, S1-3, S1-4, S1-5 on a first level. These can each be connected b downlinks to the nodes in five areas. They are also connected by uplinks to a second-level scale area S2. Such a tree will have a series of scale factors, which may be different from each other. The chosen distribution of scale factors will depend on design constraints, such as the relative cost of nodes and interconnections in the implementing technology, whether there are to be external links at intermediate levels, and the media capacity to be accommodated by the external links. Note that any scale level may or may not have external links, but the capacity of the nodes bearing those nodes will have to be doubled, to keep the structure balanced.

As shown in Table 4, each added scale increases the node density in a uniform manner and marginally decreases the connective performance. For example, FIG. 14 shows a two-scale, five-node star topology that increases node density to 155.

TABLE 4

| Topology, | | |
|---|---|---|
| Scaled Star, n = 5 | Minimum Hops | Maximum Hops |
| S = 1 | 1 | 3 |
| S = 2 | 1 | 5 |
| S = 3 | 1 | 7 |
| S = etc. | 1 | 1 + 2S |

Table 5 summarizes characteristics of the scaled star topology in the same format used for star topology and lattice topology.

TABLE 5

| | Total | | Min. | Max. |
|---|---|---|---|---|
| Node (s) | Links | Links per Node | Hops | Hops |
| Σn\hat{ }(s + 1), | See | See Below. | | |
| From | below. | | | |
| s = 0 | | | | |
| 30 (1) | 85 | 75@S0, 10@S1 | 1 | 3 |
| 155 (2) | 510 | 425@S0, 75@S1, 10@S2 | 1 | 5 |
| 780 (3) | 2635 | 2125@S0, 425@S1, 75@S2, 10@S3 | 1 | 7 |
| 3125 (4) | 13260 | 10625@S0, 2125@S1, 425@S2, | 1 | 9 |
| | | 75@S3, 10@S4 | | |

The total number of nodes is derived from Σnˆ(s+1), with s=0. The total number of links is derived from Σnˆ(s−1)[(nˆ3)+2(nˆ2)−n]/2, with s=1. Links per node are terms within the expanded series for total links. Note that congestion cannot occur provided the total data flow into a high-density switch (or backbone network) never exceeds the total data flow out and if the bandwidth between nodes at each scale is equal to or greater than (nˆs)bw, where bw represents area bandwidth.

Star, lattice, and scale star topologies will now be compared. Throughout this discussion, n=5, was used as the area connectivity depth. When inter-scale connections are included, however, this depth becomes six. The connective density of this type of network can therefore be fairly compared with the scale of a cubic lattice topology. In practice, the number of scales, nodes/area, and connections/node are design parameters that allow for adjustment of networking parameters. Table 6 presents parameters for the scaled star topology.

TABLE 6

| | Total | | Min. | Max. |
|---|---|---|---|---|
| Node (s) | Links | Links per Node | Hops | Hops |
| Σn\hat{ }(s + 1), | See | See Above | | |
| From | Above | | | |
| s = 0 | | | | |
| 30 (1) | 85 | 75@S0, 10@S1 | 1 | 3 |
| 155 (2) | 510 | 425@S0, 75@S1, 10@S2 | 1 | 5 |
| 780 (3) | 2635 | 2125@S0, 425@S1, 75@S2, 10@S3 | 1 | 7 |

Table 7 presents parameters for the mesh topology.

TABLE 7

| | | Node Links | Min & Max | |
|---|---|---|---|---|
| Node n | Total Links | (n − 1) | Hops | Fault Hops |
| | Σ(n − 1) or | | | |
| | n(n − 1)/2 | | | |
| 25 | 300 | 24 | 1 | 2 |
| 125 | 7750 | 124 | 1 | 2 |
| 500 | 124750 | 499 | 1 | 2 |

Table 8 presents parameters for the lattice topology.

TABLE 8

| | | Node Links | | | |
|---|---|---|---|---|---|
| | | Corner: 8 @ 3, | | | |
| Node | | Edges: 12(n − 2) @ 4, | | | |
| (n) | Total Links | Face: 6 (n − 2)\hat{ }2 @ 5, | Con. | Min. | Max. |
| n\hat{ }3 | (n\hat{ }3)(n − 1) | Inner: (n − 2)\hat{ }3 @ 6 | Ratio | Hops | Hops |
| 27 (3) | 54 | 8@3, 12@4, 6@5, 1@6 | 4/1 | 1 | 9 |
| 125 (5) | 500 | 8@3, 36@4, 54@5, 27@6 | 4/1 | 1 | 15 |
| 729 (9) | 5832 | 8@3, 84@4, 294@5, | 4/1 | 1 | 27 |
| | | 343@6 | | | |

The different topologies can be compared at the same approximate scale, by comparing corresponding lines of Tables 6-8. At the lowest node density, the scaled star topology has a greater connective density than the lattice topology but also has a three-fold improvement in hop performance. At a medium node density, the scaled star topology exhibits three times better hop performance than the lattice topology, but their connection densities are about the same. This occurs because the star topology scales by n times while the lattice connectivity has an nˆ3 scale factor.

At the highest node densities, scaled star topologies out-perform lattice topologies by better than three to one. And high-density scaled star topologies require less than half of the connections required by comparable lattice topology fabric. Clearly, for medium and high-density fabrics, scaled star topologies allow for significant reductions in connection density with better performance over lattice fabrics in all cases. Note that intermediate connection levels are achievable by partially populating a level or by adjusting node/area ratio. The nodes at intermediate scales are not required to have external links if the scale ratio between the level would be less than a media aggregate. These changes have no effect on hop distance performance, however, as only the addition of a scale increases hop distance.

The separation between local, remote, and high bandwidth traffic also assures that local neighbor performance never diminishes as traffic load increases. And if bandwidth scales are maintained, no congestion control is required between switches within the fabric.

Properties of star-connected topologies will now be presented in more detail. In this section, a scaled star topology is considered to be balanced when, i=j=k, for any m>0. Pure scaled star topologies are characterized by the following:
1. They include a set of subnetworks, called areas, of nodes, in which each area node is connected to each other area node to form a mesh or star of interconnections. These connections are known as intra-area connections.
2. They also include another set of subnetworks, called scales, of nodes, in which each scale node is connected to other scale nodes to form a mesh or star of interconnections. These connections are known as intra-scale connections.
3. Each node within an area connects to a specific node within the next higher scale. These interconnections are known as inter-scale connections.
4. When multiple scales exist, multiple areas of scale switches are called area scales.
5. Each scale area node connects to a specific node within the next higher scale. These connections are known as inter-scale connections.

The following formulas designate the connective relationships for areas, scales, and inter-scale connections:
Let N designate nodes, N1 . . . Ni, where i designates the total number of nodes in an area.
Let A designate areas, A1 . . . Aj, where j designates the total number of areas in a scale.
Let S designate scales, S1 . . . Sm, where m designates the total number of scales in a scaled star network topology.
Let SmNk designate scale nodes, where k designates the nodes at a scale.
   For intra-area connections, each of an area's nodes, AjNi, are interconnected such that:
A1N1 connects to A1N2, A1N3, A1N4, . . . , A1Ni
A1N2 connects to A1N1, A1N3, A1N4, . . . , A1Ni . . .
A1Ni connects to A1N1, A1N2, A1N3, . . . , A1N(i−1)
   These interconnections repeat for each Aj:
AjN1 connects to AjN2, AjN3, AjN4, . . . , AjNi
AjN2 connects to AjN1, AjN3, AjN4, . . . , AjNi . . .
AjNi connects to AjN1, AjN2, AjN3, . . . , AjN(i−1)
   For inter-area scale connections in networks where m>0, each of an area's nodes, AjNi, has inter-area connections to each scale node, S1Nk, described by the following:
A1N1 connects to S1N1.
A1N2 connects to S1N2.
A1N3 connects to S1N3. . . .
A1Ni connects to S1Nk.
   These interconnections repeat for each Aj:
AjN1 connects to S1N1.
AjN2 connects to S1N2.
AjN3 connects to S1N3. . . .
AjNi connects to S1Nk.
   For intra-scale connections for any scale and for m>0, each scale node, SmNk, has connections to each node at the same scale described by the following:
S1N1 connects to S1N2, S1N3, S1N4, . . . , S1Nk
S1N2 connects to S1N1, S1N3, S1N4, . . . , S1Nk . . .
S1Nk connects to S1N1, S1N2, S1N3, . . . , S1N(k−1)
   These interconnections repeat for each Sm:
SmN1 connects to SmN2, SmN3, SmN4, . . . , SmNk
SmN2 connects to SmN1, SmN3, SmN4, . . . , SmNk . . .
SmNk connects to SmN1, SmN2, SmN3, . . . , SmN(k−1)
   For inter-scale connections in networks where m>1, each area node, AjNi, has inter-area connections to each scale node, S1Nk, described by the following:
S1N1 connects to S2N1.
S1N2 connects to S2N2.
S1N3 connects to S2N3. . . .
S1Nk connects to S2Nk.
   These interconnections repeat for each Sm−1:
S(m−1)N1 connects to SmN1.
S(m−1)N2 connects to SmN2.
S(m−1)N3 connects to SmN3. . . .
S(m−1)Nk connects to SmNk.

The pure scaled star topology of the full networks presented above exhibit a number of advantages and are particularly well-suited to a variety of networking tasks. They can be modified in a number of ways, however, while still retaining at least some of their beneficial properties. For example, while each of the above networks exhibits a homogeneous area count n with nodes of equal capacities within an area, these numbers can be different within or between levels. Such heterogeneous area count and capacity could be the result of the deliberate partial population of areas, such as for cost reasons, or it may also be the result of other design objectives. A larger area with lower capacity nodes might serve more, smaller machines, for example, while a smaller area with higher capacity nodes might serve fewer, larger machines. Or different areas might be used for different types of communication media. Note that an abnormally small node in the lowest area level will not affect traffic congestion, except that it will reduce the amount of traffic that it is capable of handling.

In addition, while uniform scaling would best suited for many applications, the tree formed by the topology can be asymmetrical. For example, some branches may be deeper and/or may account for more traffic capacity at higher scale levels. This may be the result of deliberate partial population of areas, or other design objectives. Furthermore, while the inter-scaling-barrel connection scheme provides appropriate performance for many objectives, other inter-scale connections may be appropriate. For example, it may be possible to provide additional connections between layers, such as to improve fault performance. Certain applications may even tolerate area nodes without connections to the scale level.

The bandwidth at each scale and performance of scaled star networks will now be discussed in more detail. If the bandwidth of intra-area and inter-area connections is bw and the bandwidth of intra-scale and inter-scale connections follows the following formula, the topology will not congest under non-fault conditions.
Scale bandwidth>=(nˆs)bw, for no congestion, without path routing (optimum path only).
If the bandwidth each intra-scale connection maintains is greater than or equal to total inter-scale capacity of the lower scale connection divided by the total number of intra-connections at scale, then no congestion performance may be obtained, but a flow-based path routing protocol will be required.

Imbalanced scaled star topologies can also be constructed by connecting one or more non-star areas or sub areas of any scale within a scaled star topology. To integrate the non-star topologies into an unbalanced but scaled star topology, the connections to the next higher scale must follow the inter-scale formula presented above. No negative impact on performance at scale or inter-scale occurs within the fabric for other scaled star sub areas or sub scales. However, the performance of the imbedded non-star topologies will not follow a predictable pattern.

Another type of imbalance can exist within areas of sub-scales with a scaled star topology. This type of imbalance exists when areas at the same scale have different node densities. If the areas fall into a multiple of the next scale, it's possible to increase the number of inter-scale connections for these areas or sub scales. The capacity of intra-scale connections for the next higher scale would become the total inter-scale capacity of all sub-scale areas divided by the total connections at scale for conditions of no congestion. If the node densities are not a multiple of the number of nodes at the next scale, but the inter-scale connections formula is maintained, the fabric performs as defined for non-star area or sub scale areas.

Because each scale may be composed of more switch elements than the sub scales, many combinations of scaled star topologies exist. When designing imbalanced scale star topologies, it is important to integrate the non-star topologies into the star fabric without adversely affecting the efficiency of the fabric overall. As long as the inter-connection between the sub-area and the up scale links maintain a capacity profile of the upscale intra-scale links, no congestion will be introduced to the fabric overall by the imbalance topology.

As presented above, scaled star interconnected networks present a number of advantages for the implementation of a variety of types of networks. More complex and impure network forms may also implemented, and these may still exhibit a number of advantages over the prior art. For example, it may by possible to make changes to the node structure that impair the theoretical performance of a network, such as its balance, but do not significantly impede practical performance, because they are statistically insignificant in actual operating conditions.

The present invention has now been described in connection with a number of specific embodiments thereof. However, numerous modifications which are contemplated as falling within the scope of the present invention should now be apparent to those skilled in the art. Therefore, it is intended that the scope of the present invention be limited only by the scope of the claims appended hereto. In addition, the order of presentation of the claims should not be construed to limit the scope of any particular term in the claims.

What is claimed is:

1. A network comprising:
a first subnetwork including a first plurality of nodes interconnected by a first plurality of links, wherein nodes in the first plurality have a first capacity,
a second subnetwork including a second plurality of nodes interconnected by a second plurality of links, wherein nodes in the second plurality have a second capacity, and wherein the second capacity is higher than the first capacity, and
a third plurality of links between nodes in the first subnetwork and the second subnetwork.

2. The network of claim 1 wherein, the capacity of each particular one of the plurality of nodes in the second subnetwork is at least equal to the total capacity of all nodes in the first subnetwork that connect to that particular node in the second subnetwork.

3. The network of claim 2 wherein the first subnetwork includes a fabric capable of carrying any combination of traffic within the first network without requiring such traffic to enter the second subnetwork.

4. The network of claim 1 wherein the first subnetwork includes a fabric capable of carrying any combination of traffic within the first subnetwork without requiring such traffic to enter the second subnetwork.

5. The network of claim 1 wherein the first plurality of links and the first plurality of nodes of the first subnetwork form a mesh topology.

6. The network of claim 1 wherein the first plurality of links and the first plurality of nodes of the first subnetwork form a mesh topology and wherein the second plurality of links and the second plurality of nodes of the second subnetwork form a mesh topology.

7. The network of claim 1 wherein the capacity of the first node includes its worst-case bandwidth and the capacity of the second node includes its worst-case bandwidth.

8. The network of claim 1 wherein the second subnetwork includes a fabric capable of carrying any combination of traffic from the first network.

9. The network of claim 1 further including at least a third subnetwork having a plurality of nodes interconnected by a fourth plurality of links, further including a fifth plurality of links between nodes in the third subnetwork and in the second subnetwork, and wherein nodes in the fourth plurality have a third capacity lower than the second capacity.

10. The network of claim 9 wherein different nodes in each of the first and third subnetworks are connected to different nodes in the second subnetwork.

11. The network of claim 1 further including at least a third subnetwork having a plurality of nodes interconnected by a fourth plurality of links, further including a fifth plurality of links between nodes in the second subnetwork and in the third subnetwork, and wherein nodes in the fourth plurality have a third capacity higher than the second capacity.

12. The network of claim 11 wherein the first and third capacities are equal.

13. The network of claim 1 further including at least three further subnetworks each having a plurality of nodes interconnected by a respective plurality of links, further including at least three further pluralities of links respectively between nodes in the three further subnetworks and the second subnetwork, and wherein nodes in the three further pluralities have a third capacity lower than the second capacity.

14. The network of claim 1 further including routing logic operative to route signals from any of the nodes in the network to any other nodes in the network via a path that is independent of all other traffic in the network.

15. The network of claim 1 further including communication-enabling logic operative to enable communication between any two of the nodes based on the available capacity of those two nodes.

16. The network of claim 1 wherein the capacity and topology of the interconnections between the subnetworks define a network having a monotonic performance characteristic.

17. The network of claim 1 wherein each of the nodes in the first subnetwork are connected to a different node in the second subnetwork.

18. A networking method, comprising:
inquiring whether two nodes in the network have sufficient capacity to communicate, and
determining whether to allow communication between the two nodes based on results of the step of inquiring but otherwise independent of existing traffic allowed through the network in previous steps of allowing, and
allowing communication traffic to pass between nodes in a network based on the step of determining.

19. The method of claim 18 wherein the step of determining is based only on the results of the step of inquiring.

20. A networking method, comprising:
providing a first subnetwork including a first plurality of nodes interconnected by a first plurality of links,
providing a second subnetwork including a second plurality of nodes interconnected by a second plurality of links,
providing a third subnetwork including a third plurality of nodes interconnected by a third plurality of links,
providing a plurality of links between nodes in the first subnetwork and the second subnetwork and a plurality of links between nodes in the second subnetwork and the third subnetwork,
inquiring whether a node in the third subnetwork has sufficient capacity to receive a transfer, and
determining whether to perform a transfer from a node in the first subnetwork to the node in the third subnetwork based on results of the step of inquiring.

21. A network comprising:
means interconnecting a first area of nodes,
means interconnecting a first scale of nodes, and
means interconnecting the first area and the first scale.

22. The network of claim 21 including means for balancing the first area of nodes and the first scale of nodes.

23-33. (canceled)
